(19) United States
(12) Patent Application Publication
(10) Pub. No.: US 2015/0362420 A1
(43) Pub. Date: Dec. 17, 2015

(54) SYSTEMS FOR SINGLE OR MULTIPLE CELL COUNTING AND DISPENSING

(71) Applicant: WaferGen, Inc., Fremont, CA (US)

(72) Inventors: Patricio A. Espinoza Vallejos, Fremont, CA (US); Alain Mir, Fremont, CA (US); Syed A. Husain, Fremont, CA (US); Michael Slater, Madison, WI (US); Maithreyan Srinivasan, Santa Clara, CA (US)

(21) Appl. No.: 14/738,183

(22) Filed: Jun. 12, 2015

Related U.S. Application Data
(60) Provisional application No. 62/011,875, filed on Jun. 13, 2014.
(60) Provisional application No. 62/079,348, filed on Nov. 13, 2014.

(51) Int. Cl. G01N 15/10; G01N 15/12

(52) U.S. Cl. CPC G01N 15/1031; G01N 15/1218; G01N 2015/1254; G01N 2015/1062

(57) ABSTRACT

The present invention provides methods, device, assemblies, and systems for counting and dispensing single or multiple cells (e.g., into the open wells of a multi-well testing device). In certain embodiments, the systems comprise: a) a fluid movement component composed of upstream and downstream electrode conduits connected to a non-conductive conduit, and b) an electronic signal detector electrically linked to the upstream and downstream electrode conduits such that, when a fluid is present in the fluid movement component, an electrical circuit is established that is altered when a cell passes through the non-conductive conduit. In other embodiments, the systems comprises a) a fluid movement component composed of an upstream electrode conduit connected to a non-conductive conduit, b) an in-well electrode, and c) an electronic signal detector electrically linked to the upstream electrode conduit and the in-well electrode.

The present application claims priority to U.S. Provisional Applications 62/011,267, filed Jun. 13, 2014 and 62/079,348, filed Nov. 13, 2014, both of which are herein incorporated by reference in their entireties.

### FIELD OF THE INVENTION

The present invention provides methods, device, assemblies, and systems for counting and dispensing single or multiple cells (e.g., into the open wells of a multi-well testing device). In certain embodiments, the systems comprise: a) a fluid movement component composed of upstream and downstream electrode conduits connected to a non-conductive conduit, and b) an electronic signal detector electrically linked to the upstream and downstream electrode conduits such that, when a fluid is present in the fluid movement component, an electrical circuit is established that is altered when a cell passes through the non-conductive conduit. In other embodiments, the systems comprises a) a fluid movement component composed of an upstream electrode conduit connected to a non-conductive conduit, b) an in-well electrode, and c) an electronic signal detector electrically linked to the upstream electrode conduit and the in-well electrode such that, when: i) a fluid is present in the fluid movement component, ii) the distal end of the non-conductive conduit is in a fluid-contain well, and iii) the in-well electrode is in the fluid-containing well, then an electrical circuit is established that is altered when a cell passes through the non-conductive conduit.

### BACKGROUND

Geneticists are striving to characterize complex diseases like cancer, autoimmune and neurological disorders, but finding the underlying mechanisms driving these diseases has been elusive. Somatic mutations, spontaneous variants that accumulate in cells over a lifetime, are a major factor that drives disease onset and reoccurrence. As cells accumulate new mutations, they form polyclonal cell populations that co-exist with normal cells. Sequencing bulk cell populations can mask the underlying heterogeneity of these unique rare cell types, making it difficult to distinguish them from normal germline mutations. The best way to reveal these differences and visualize the clonal architecture is to sequence individual cells in the population. While single-cell sequencing can help uncover mechanisms of complex disease, traditional approaches are expensive, labor intensive, and require large sample input. What is needed are methods to isolate single cells that, for example, are amenable for use with multi-well devices.

### SUMMARY OF THE INVENTION

The present invention provides methods, device, assemblies, and systems for counting and dispensing single or multiple cells (e.g., into the open wells of a multi-well testing device). In certain embodiments, the systems comprise: a) a fluid movement component composed of upstream and downstream electrode conduits connected to a non-conductive conduit, and b) an electronic signal detector electrically linked to the upstream and downstream electrode conduits such that, when a fluid is present in the fluid movement component, an electrical circuit is established that is altered (e.g., conductivity of the circuit drops) when a cell passes through the non-conductive conduit. In other embodiments, the systems comprises a) a fluid movement component composed of an upstream electrode conduit connected to a non-conductive conduit, b) an in-well electrode, and c) an electronic signal detector electrically linked to the upstream electrode conduit and the in-well electrode such that, when: i) a fluid is present in the fluid movement component, ii) the distal end of the non-conductive conduit is in a fluid-contain well, and iii) the in-well electrode is in the fluid-containing well, then an electrical circuit is established that is altered (e.g., conductivity of the circuit drops) when a cell passes through the non-conductive conduit.

In some embodiments provided herein are systems comprising: a) a fluid movement component configured to dispense at least one cell in a fluid into a container (e.g., a well of a 96-well plate or a multi-well chip), wherein the fluid movement component comprises: i) an upstream electrode conduit (e.g., metal tube) comprising a proximal end, a distal end, and an upstream fluid-carrying channel (e.g., passage through a tube), wherein the upstream electrode conduit is electrically conductive and able to transmit the cell in the fluid therethrough; ii) a downstream electrode conduit (e.g., metal tube) comprising a proximal end, a distal end, and a downstream fluid-carrying channel, wherein the downstream electrode conduit is electrically conductive and able to transmit the cell in the fluid therethrough; and iii) a non-conductive conduit (e.g., plastic, fused silica, or glass; tube, capillary tube, emitter, etc.) comprising a proximal end, a distal end, and a non-conductive fluid-carrying channel, wherein the non-conductive conduit is non-electrically conductive and able to transmit the cell in the fluid therethrough, wherein the proximal end of the non-conductive conduit is connected to (e.g., push fit, glued, etc.) the distal end of the upstream electrode conduit, and the distal end of the non-conductive conduit is connected (e.g., push-fit, glued, etc.) to the proximal end of the downstream electrode conduit; and b) an electronic signal detector (e.g., current meter) that is, or configured to be, electrically linked (e.g., via wires) to both the upstream electrode conduit and the downstream electrode conduit such that: i) when fluid is present in the fluid movement component an electrical circuit is established, and ii) when a cell present in the fluid passes through the non-conductive conduit, a change in conductivity, current, or impedance of the electrical circuit is generated that is detectable by the electronic signal detector. In certain embodiments, the electronic signal detector is electrically linked to the upstream electrode conduit via a first connection wire, and the electronic signal detector is electrically linked to the downstream electrode conduit via a second connection wire.

In particular embodiments, provided herein are methods of detecting a cell (e.g., at least one cell, at least two cells, etc.) passing through a fluid movement component comprising: a) providing: i) the system described above (and/or elsewhere herein), wherein the electronic signal detector is electrically linked to both the both the upstream electrode conduit and the downstream electrode conduit, and ii) at least one cell in a fluid; b) passing the fluid through the fluid movement component such that the electrical circuit is established; and c) detecting a change in conductivity, current, or impedance (e.g., detecting a reduction in conductivity) of the electrical circuit with the electronic signal detector when the at least one cell in the fluid passes through the non-conductive conduit, thereby detecting the at least one cell moving through the fluid movement component. In certain embodiments, the methods further comprise d) dispensing the at least one cell into a well based on detecting the at least one cell moving through the fluid movement component.

In some embodiments, provided herein are articles of manufacture comprising: a fluid movement component configured to dispense at least one cell in a fluid into a container, wherein the fluid movement component comprises: a) an upstream electrode conduit comprising a proximal end, a distal end, and an upstream fluid-carrying channel, wherein the upstream

electrode conduit is electrically conductive and able to transmit the cell in the fluid therethrough; b) a downstream electrode conduit comprising a proximal end, a distal end, and a downstream fluid-carrying channel, wherein the downstream electrode conduit is electrically conductive and able to transmit the cell in the fluid therethrough; and c) a non-conductive conduit comprising a proximal end, a distal end, and a non-conductive fluid-carrying channel, wherein the non-conductive conduit is non-electrically conductive and able to transmit the cell in the fluid therethrough, wherein the proximal end of the non-conductive conduit is connected to the distal end of the upstream electrode conduit, and the distal end of the non-conductive conduit is connected to the proximal end of the downstream electrode conduit, and wherein the upstream and downstream electrode conduits are configured to be electrically linked to an electronic signal detector such that: i) when fluid is present in the fluid movement component an electrical circuit is established, and ii) when a cell present in the fluid passes through the non-conductive conduit, a change in conductivity, current, or impedance (e.g., a reduction in the conductivity) of the electrical circuit is generated that is detectable by the electronic signal detector.

In certain embodiments, provided herein are systems comprising: a) a fluid movement component configured to dispense at least one cell in a fluid, wherein the fluid movement component comprises: i) an upstream electrode conduit comprising a proximal end, a distal end, and an upstream fluid-carrying channel, wherein the upstream electrode conduit is electrically conductive and able to transmit the cell in the fluid therethrough; and ii) a non-conductive conduit comprising a proximal end, a distal end, and a non-conductive fluid-carrying channel, wherein the non-conductive conduit is non-electrically conductive and able to transmit the cell in the fluid therethrough, wherein the proximal end of the non-conductive conduit is connected to the distal end of the upstream electrode conduit; b) an in-well electrode; and c) an electronic signal detector that is, or is configured to be, electrically linked to both the upstream electrode conduit and the in-well electrode such that: i) when: A) fluid is present in the fluid movement component, B) the distal end of the non-conductive conduit is in a fluid-containing well, and C) the in-well electrode is in the fluid-containing well, then an electrical circuit is established, and ii) when the cell in the fluid passes through the non-conductive conduit, a change in conductivity, current, or impedance of the electrical circuit is generated that is detectable by the electronic signal detector. In some embodiments, system further comprises the fluid-containing well, wherein at least part of the in-well electrode and the distal end of the non conductive conduit are in the fluid-containing well.

In some embodiments, provided herein are methods of detecting a cell passing through a fluid movement component comprising: a) providing: i) at least one cell in a fluid, ii) a fluid-containing well, and iii) the system described above (and/or elsewhere herein), wherein the electronic signal detector is electrically linked to both the upstream electrode conduit and the in-well electrode, and the wherein at least part of the in-well electrode and the distal end of the non-conductive conduit are in the fluid-containing well; b) passing the fluid through the fluid movement component such that the electrical circuit is established; and c) detecting a change in conductivity, current, or impedance of the electrical circuit with the electronic signal detector when the at least one cell in the fluid passes through the non-conductive conduit, thereby detecting the at least one cell moving through the fluid movement component.

In certain embodiments, provided herein are articles of manufacture comprising a fluid movement component configured to dispense at least one cell in a fluid into a container, wherein the fluid movement component comprises: a) an upstream electrode conduit comprising a proximal end, a distal end, and an upstream fluid-carrying channel, wherein the upstream electrode conduit is electrically conductive and able to transmit the cell in the fluid therethrough; and b) a non-conductive conduit comprising a proximal end, a distal end, and a non-conductive fluid-carrying channel, wherein the non-conductive conduit is non-electrically conductive and able to transmit the cell in the fluid therethrough, wherein the proximal end of the non-conductive conduit is connected to the distal end of the upstream electrode conduit, and wherein the upstream electrode conduit is configured to be electrically linked to an in-well electrode and an electronic signal detector such that: i) when: A) fluid is present in the fluid movement component, B) the distal end of the non-conductive conduit is in a fluid-containing well, and C) at least part of the in-well electrode is in the fluid-containing well, then an electrical circuit is established, and ii) when the cell in the fluid passes through the non-conductive conduit, a change in conductivity, current, or impedance of the electrical circuit is generated that is detectable by the electronic signal detector.

In certain embodiments, the fluid movement component is further configured to aspirate liquid from a source container. In other embodiments, the non-conductive fluid-carrying channel is between 100 μm and 10 cm long, or between 50 um and 1 cm long (e.g., 50 μm . . . 400 μm . . . 800 μm 1.5 mm . . . 6.5 mm . . . 1 cm . . . 10 cm). In some embodiments, the systems further a fluid source component attached to proximal end of the upstream electrode conduit. In other embodiments, the non-conductive fluid-carrying channel has a diameter, at its narrowest point, of between 2 μm and 1.0 mm, or between 10 μm and 500 μm (e.g., 2.0 μm . . . 3.0 μm . . . 4 μm . . . 15 μm . . . 125 μm . . . 350 μm . . . and 500 μm). In particular embodiments, the systems herein further comprise a second or third or fourth, or fifth fluid movement component which is also electrically linked or configured to be electrically linked to the electronic signal detector.

In particular embodiments, the at least one cell is selected from the group consisting of: a platelet with a diameter of about 2 μm, a red blood cell with a diameter of about 3 to 8 μm, a neutrophil with a diameter of about 8-10 μm, a lymphocyte with a diameter of about 6-12 μm, an exocrine cell with a diameter of about 10 μm, a fibroblast with a diameter of about 10-15 μm, an osteocyte with a diameter of about 10-20 μm, a chondrocyte or a liver cell with a diameter of about 20 μm, a goblet or ciliated cell with a size of about 50 μm long and 5-10 μm wide, a macrophage with a diameter of about 20-80 μm, a hematopoietic stem cell with a diameter of about 30-40 μm, an adipocyte filled with stored lipid with a diameter of about 70-120 μm, and a neuron with a diameter of about 4-120 μm. In certain embodiments, the cell is prokaryotic or eukaryotic. In some embodiments, the cell is mammalian cell (e.g., human cell). In some embodiments, the non-conductive conduit further comprises a restrictor element (which forms the channel in the non-conductive conduit). In certain embodiments, the restrictor element comprises a single cell channel sized to allow only a single cell to pass out of the distal end of the non-conductive component at once. In other embodiments, the restrictor element comprises a focusing cone or similar cell directing component.

In certain embodiments, the systems employ a plurality of fluidic channels each with a nozzle, where a first electrode is in each fluidic channel and a second electrode is either downstream of the first electrode in the nozzle or is in, or configured to be in, a source well of a source container such that a coulter counter is established allowing the detection and counting of single cells being dispensed or aspirated. In other embodiments, the first and second electrodes are replaced by a pressure sensor. In other embodiments, provided herein are liquid dispensing components with a detection channel between a dispensing micro-channel and a cell re-circulating channel (or cell reservoir), where negative pressure exerted on the dispensing micro-channel causes single cells to traverse the detection channel such that they can be counted and/or sized based on the change in impedance in the detection channel.

In some embodiments, provided herein are systems comprising: a) a fluid movement component configured to: i) aspirate a liquid sample from a source container which comprises a plurality of source wells (e.g., 384 source wells); and ii) dispense a liquid sample into a multi-well testing device which comprises a plurality of open wells (e.g., where the fluid movement component either contacts or does not contact liquid in the wells when dispensing), wherein the fluid movement component comprises a plurality of fluidic channels each comprising a non-conductive nozzle; b) an electronic signal detector; c) a plurality of first electrodes each of which is electrically linked to the electronic signal detector, wherein one of the first electrodes is at least partially inside each of the plurality of fluidic channels; and d) a plurality of second electrodes each of which is electrically linked to the electronic signal detector, wherein one of the second electrodes is: i) at least partially inside each of the non-conductive nozzles downstream of the one first electrode, or ii) configured to be inserted, or is inserted, at least partially inside each of the plurality of source wells of the source container; wherein the first and second electrodes are arranged such that when a single cell in the liquid sample passes between the first and second electrodes in any of the plurality of fluidic channels, the single cell is detected by the electronic signal detector due to a change in current or impedance (e.g., a drop in current).

In certain embodiments, provided herein are robotic liquid sample handling systems comprising: a) a first securing component configured to secure a source container in place at a first location, wherein the source container is configured to hold liquid sample and comprises a plurality of source wells (e.g., 384 source wells); b) a second securing component configured to secure a multi-well testing device in place at a second location, wherein the multi-well testing device comprises a plurality of open wells (e.g., 5184 open wells); c) a fluid movement component configured to aspirate the liquid sample from the source container and dispense the liquid sample into the multi-well testing device, wherein the fluid movement component comprises a plurality of fluidic channels each comprising a non-conductive nozzle, d) a robotic arm component configured to move between the first location and the second location, wherein the robotic arm component comprises a robotic arm and the fluid movement component; e) an electronic signal detector; f) a plurality of first electrodes each of which is electrically linked to the electronic signal detector, wherein one of the first electrodes is at least partially inside each of the plurality of fluidic channels; and g) a plurality of second electrodes each of which is electrically linked to the electronic signal detector, wherein one of the second electrodes is: i) at least partially inside each of the non-conductive nozzles downstream of the one first electrode (e.g., for liquid contact or non liquid contact dispensing), or ii) configured to be inserted, or is inserted, at least partially inside each of the plurality of source wells of the source container for aspiration; wherein the first and second electrodes are arranged such that when a single cell in the liquid sample passes between the first and second electrodes in any of the plurality of fluidic channels, the single cell is detected by the electronic signal detector due to a change in current or impedance (e.g., a drop in current). In certain embodiments, the second electrode is located on the multi-well testing device to achieve detecting during contact dispensing. In some embodiments, detection during non-contact dispensing is achieved with the downstream electrode on the microfluidic nozzle or capillary.

In certain embodiments, provided herein are methods comprising: a) providing: i) the robotic liquid handling systems described herein, ii) a multi-well testing device comprising a plurality of open wells, and iii) a source container holding a liquid sample (e.g., which contains cells), where the source container comprises a plurality of source wells (e.g., 384 source wells); b) inserting the source container into the first securing component; c) inserting the multi-well testing device into the second securing component; d) activating the robotic liquid handling system: i) such that the fluid movement component aspirates the liquid sample from the source container at the first position and dispenses the liquid sample into at least some of the plurality of open wells of the multi-well testing device at the second location (e.g., where the dispensing happens rapidly, such as less than a second or less than a quarter second to fill a particular open well); and ii) such that electronic signal detector detects multi-well cell number data which comprises the number of cells in the liquid sample dispensed into each of the at least some of the plurality of open wells based on the change in current/impedance from a single cell passing between the first and second electrodes in any of the plurality of fluidic channels. In certain embodiments, such data also includes the number of cells dispensed into a well being zero, as well as one cell, two cells, three cells, or more. In particular embodiments, wells that have zero cells dispensed (e.g., have liquid dispensed, but no cell), the system can automatically or be directed to come back to such wells and dispense at least one cell. In particular embodiments, the system dispense one cell, and only one cell, into all or most of the open wells of the multi-well testing device.

In certain embodiments, the system further comprises a computer storage and processing component operably linked to the electronic signal detector, wherein the computer storage and processing component is configured to receive the multi-well cell number data from the electronic signal detector and process the cell number data to generate a database, wherein the database indicates which of the plurality of open wells were filled and the number of cells in each of the plurality of open wells. In some embodiments, the computer storage and processing component comprises a software component that is located on the storage component. In particular embodiments, the software component automatically or allows a user (e.g., through a GUI) to access the database and determine what wells: 1) need a cell (e.g., do not yet have a cell or the lysed components of a cell); 2) are ready for processing reagents (e.g., primers, lyse agent, polymerase, sequencing reagents, etc.), and 3) have more than one cell (e.g., and might not be further employed). In certain embodiments, the software can control the speed of the dispensing and can calculate how fast the fluidic channels should be moved over each open well so that each well receives a single cell.

In certain embodiments, provided herein are systems comprising: a) a fluid movement component configured to dispense a liquid sample into a multi-well testing device and/or aspirate a liquid sample from a source container comprising a plurality of source wells, wherein the fluid movement component comprises a plurality of fluidic channels each comprising a nozzle; b) an electronic signal detector; and c) a plurality of pressure sensors each of which is electrically linked to the electronic signal detector, wherein one of the pressure sensors is at least partially inside each of the plurality of fluidic channels; wherein the pressure sensor is configured such that when a single cell in the liquid sample passes by the pressure sensor in any of the plurality of fluidic channels, the single cell is detected by the electronic signal detector due to a change in pressure on the pressure sensor.

In some embodiments, provided herein are systems comprising: a) a first securing component configured to secure a source container in place at a first location, wherein the source container is configured to hold liquid sample, and wherein the source container comprises a plurality of source wells; b) a second securing component configured to secure a multi-well testing device in place at a second location, wherein the multi-well testing device comprises a plurality of open wells; c) a fluid movement component configured to aspirate the liquid sample from the source container and dispense the liquid sample into the multi-well testing device, wherein the fluid movement component comprises a plurality of fluidic channels each comprising a nozzle, d) a robotic arm component configured to move between the first location and the second location, wherein the robotic arm component comprises a robotic arm and the fluid movement component; e) an electronic signal detector; f) a plurality of pressure sensors each of which is electrically linked to the electronic signal detector, wherein one of the pressure sensors is at least partially inside each of the plurality of fluidic channels; wherein the pressure sensor is configured such that when a single cell in the liquid sample passes by the pressure sensor (e.g., in the dispensing direction or the aspirating direction) in any of the plurality of fluidic channels, the single cell is detected by the electronic signal detector due to a change in pressure on the pressure sensor.

In some embodiments, provided herein are methods comprising: a) providing: i) a robotic liquid handling system as described herein, ii) a multi-well testing device comprising a plurality of open wells, and iii) a source container holding a liquid sample, wherein the source container comprises a plurality of source wells; b) inserting the source container into the first securing component; c) inserting the multi-well testing device into the second securing component; d) activating the robotic liquid handling system: i) such that the fluid movement component aspirates the liquid sample from the source container at the first position and dispenses the liquid sample into at least some of the plurality of open wells of the multi-well testing device at the second location; and ii) such that electronic signal detector detects multi-well cell number data which comprises the number of cells in the liquid sample dispensed into each of the at least some of the plurality of open wells based on the change in pressure from a single cell on the pressure sensor.

In certain embodiments, the system further comprises a computer storage and processing component operably linked to the electronic signal detector, wherein the computer storage and processing component is configured to receive the multi-well cell number data from the electronic signal detector and process the cell number data to generate a database, wherein the database indicates which of the plurality of open wells were filled and the number of cells in each of the plurality of open wells. In particular embodiments, the computer storage component comprises a software component configured to operate the system and access the database.

In particular embodiments, the multi-well testing device comprises at least 3 of the open wells and/or the source container comprises a least 3 source wells (e.g., at least 3 . . . 25 . . . 75 . . . 150 . . . 384 . . . 1000 . . . 2000 . . . 5000 . . . 10,000 . . . or at least 20,000 open wells and/or source wells). In particular embodiments, the multi-well testing device comprises 1000-6000 of the open wells. In further embodiments, the system comprises the multi-well testing device. In some embodiments, each of the fluidic channels comprises a non-conductive nozzle with a diameter between 0.010 mm to 1.5 mm (e.g., 0.010 mm . . . 0.4 mm . . . 0.8 mm . . . 1.1 mm . . . 1.5 mm). In certain embodiments, the fluidic channels are capillary tubes. In further embodiments, the fluid movement component is further configured to aspirate a liquid sample from a liquid sample source. In certain embodiments, the non-conductive nozzle is composed of plastic or ceramic. In further embodiments, the electronic signal detector comprises a current meter, or voltmeter, or multi-meter. In particular embodiments, the electronic signal detector is a digital lock-in amplifier (e.g., SR810 and SR830 DSP lock-in amplifier from Stanford Research Systems).

In particular embodiments, the single cell is detected by the electronic signal detector and cell number data is generated for one particular open well of the plurality of open wells in the multi-well testing device, wherein the cell number data comprises the location of the one particular open well in the multi-well testing device and the number of cells dispensed into the one particular open well. In some embodiments, the systems further comprise: a computer storage and processing component operably linked to the electronic signal detector, wherein the computer storage and processing component is configured to receive the cell number data from the electronic signal detector and process the cell number data (e.g., with software present on the storage component) to generate a database, wherein the database indicates which of the plurality of open wells were filled and the number of cells in each of the plurality of open wells. In particular embodiments, software loaded on the storage component employs the data in the database to direct future action (e.g., re-loading of cells into empty well; dispensing processing reagents into wells that contain a single cell; recording results of processing the wells; etc.).

In particular embodiments, the plurality of fluidic channels comprises at least four fluidic channels (e.g., 4 . . . 8 . . . 12 . . . 25 . . . 35 . . . or more). In some embodiments, the systems further comprise: a first securing component (e.g., pivoting arms and/or screws) configured to secure a source container in place at a first location, wherein the source container is configured to hold liquid sample. In further embodiments, the source container comprises a plurality of source wells each with a different liquid sample (e.g., at least 4 . . . 25 . . . 100 . . . 384 . . . or 1000 different liquid samples). In further embodiments, the systems further comprise the source container at a first location, wherein the source container holds a liquid sample. In additional embodiments, the systems further comprise: a second securing component (e.g., pivoting arm, screws, etc.) configured to secure the multi-well testing device at a second location. In additional embodiments, the second securing component configured to secure the multi-well testing device at a second location.

In certain embodiments, the systems further comprise a robotic arm component comprising a robotic arm and the fluid movement component. In other embodiments, the system further comprises a robotic arm component configured to move between the first location and the second location, wherein the robotic arm component comprises a robotic arm and the fluid movement component. In additional embodiments, the systems further comprise a hood component, wherein the hood component encloses all the other recited components (e.g., see FIG. 1). In other embodiments, the hood component provides a sealed and humidified environment for the dispensing.

In particular embodiments, at least some of the plurality of open wells in the multi-well testing devices have a volume between 0.1 nanoliters and 500 nanoliters (e.g., about 0.1 nl . . . 0.9 nl . . . 1.5 nl . . . 5.0 nl . . . 10 nl . . . 20 nl . . . 35 nl . . . 50 nl . . . 75 nl . . . 100 nl . . . 150 nl . . . 300 nl . . . 450 nl . . . 500 nl). In particular embodiments, at least some of the plurality of wells has a volume between 1.0 nanoliter and 250 nanoliters (e.g., 1-250 nl, 10-200 nl, 25-150 nl, 40-100 nl, or 50-100 nl). In some embodiments, the plurality of wells comprises at least 3 open wells (e.g., 3 . . . 10 . . . 100 . . . 350 . . . 500 . . . 750 . . . 1000 . . . 1500 . . . 3000 . . . 5000 . . . 7500 . . . 10,000 . . . 15,000 . . . 20,000 . . . 30,000 . . . 45,000 or more open wells).

In additional embodiments, the multi-well testing device (e.g., chip) has a length of 10 mm to 200 mm (e.g., 10 mm . . . 50 mm . . . 100 mm . . . 150 mm . . . or 200 mm), a width of 10 mm to 200 mm (e.g., 10 mm . . . 50 mm . . . 100 mm . . . 150 mm . . . or 200 mm), and a thickness of 0.1 mm to 10 centimeters (e.g., 0.1 mm . . . 1.0 mm . . . 10 mm . . . 10 cm). In other embodiments, the substrate used for the multi-well testing device comprises a material selected from the group consisting of: glass, ceramics, metalloids, silicon, a silicate, silicon nitride, silicon dioxide, quartz, gallium arsenide, a plastic, filled plastics, and an organic polymeric material. In additional embodiments, the multi-well device (e.g., chip) further comprises individually-controlled heating elements, each of which is operably coupled to a well.

In some embodiments, provided herein are articles of manufacture, or systems, comprising a liquid dispensing component with a proximal end and a distal end, wherein the liquid dispensing component comprises: a) a dispensing micro-channel extending between the proximal end and the distal end of the liquid dispensing component, wherein the dispensing micro-channel has an opening in the distal end of the liquid dispensing component that allows liquid to be dispensed, and wherein the dispensing micro-channel is, or is configured to be, operably linked to a pneumatic component such that negative pressure can be generated in the dispensing micro-channel; b) a cell source component, wherein the cell source comprises either: i) a first cell reservoir comprising a cell focusing zone, or ii) a re-circulating channel, wherein the re-circulating channel comprises a cell-source channel fluidically linked to a cell-return channel, c) a detection channel extending between the dispensing channel and the focusing zone of the first cell reservoir or the cell-source channel; and d) a cell detection component comprising: i) a first electrode at least partially in the dispensing channel and configured to be electrically linked to an electronic signal detector, and ii) a second electrode at least partially in the detection channel and configured to be electrically linked to the electronic signal detector, wherein the first and second electrodes are arranged such that when a single cell in a liquid sample enters the detection channel and passes between the first and second electrodes, the single cell's presence and/or size is detectable by the electronic signal detector due to a change in current or impedance.

In certain embodiments, the negative pressure is generated in the dispensing micro-channel when the opening is plugged (e.g., an air or water tight seal is formed in the opening of the micro-channel). The seal can be achieved by an external mechanically controlled plug or by micro valve located on the dispensing channel. In some embodiments, the re-circulating channel runs substantially parallel to the dispensing micro-channel; and/or wherein the first or second cell reservoir is at or near the proximal end of the liquid dispensing component. In further embodiments, both the cell-source channel and the cell-return channel are, or are configured to be, fluidically linked to a cell reservoir. In additional embodiments, the articles and systems further comprise the electronic signal detector. In other embodiments, the cell source component comprises the first cell reservoir. In additional embodiments, the cell source component comprises a re-circulating channel.

In additional embodiments, the articles and system further comprise a plug component configured to be placed on the opening of the liquid dispensing component such that an air tight seal is created. In other embodiments, articles and systems further comprise the pneumatic component, wherein the pneumatic component is capable of generating the negative pressure. In certain embodiments, the pneumatic component is at or near the proximal end of the liquid dispensing component. In additional embodiments, the negative pressure generated by the pneumatic component is sufficiently strong to draw the at least one cell in the liquid sample through the detection channel into the dispensing channel. In certain embodiments, the pneumatic component comprises a container with compressed air or a syringe.

In some embodiments, the systems or articles further comprise a connecting tube, wherein the proximal end of the dispensing channel is, or is configured to be, connected to the connecting tube, and wherein the pneumatic component is, or is configured to be, connected to the tube. In further embodiments, the re-circulating channel is, or is configured to be, connected to a micro-pump or other source of negative pressure.

In certain embodiments, the cell-source channel and the cell-return channel form a closed loop. In other embodiments, the cell-source channel the cell-return channel do not form a closed loop. In further embodiments, the dispensing micro-channel and/or the re-circulating channel has a diameter from about 50 to about 250 micrometers (e.g., 50 . . . 100 . . . 175 . . . 225 . . . or about 250 micrometers). In additional embodiments, the detection channel has a diameter from about 1 to about 50 micrometers (e.g., about 1 . . . 20 . . . 35 . . . 42 . . . or about 50 micrometers). In further embodiments, the detection channel is sized such that only a single cell can enter the detection channel at once, and wherein the single cell is selected from the group consisting of: osteocyte, chondrocyte, nerve cell, epithelial cell, muscle cell, secretory cell, adipose cell, red blood cell, white blood cell, platelet, and thrombocyte.

In particular embodiments, provided herein are systems comprising: a) a liquid dispensing component with a proximal end and a distal end, wherein the liquid dispensing component comprises; i) a dispensing micro-channel extending between the proximal end and the distal end of the liquid dispensing component, wherein the dispensing micro-channel has an opening in the distal end of the liquid dispensing component that allows liquid to be dispensed, and wherein the dispensing micro-channel is, or is configured to be, operably linked to a pneumatic component such that negative pressure can be generated in the dispensing micro-channel when the opening is plugged; ii) a cell source component, wherein the cell source comprises a cell reservoir or cell-source channel; iii) a detection channel extending between the dispensing channel and the cell source component; and iv) a cell detection component comprising: A) a first electrode at least partially in the dispensing channel and configured to be electrically linked to an electronic signal detector, and B) a second electrode at least partially in the detection channel and configured to be electrically linked to the electronic signal detector, wherein the first and second electrodes are arranged such that when a single cell in a liquid sample enters the detection channel and passes between the first and second electrodes, the single cell is detectable by the electronic signal detector due to a change in current or impedance; and b) a plug component configured to be inserted into the opening of the liquid dispensing component (e.g., such that an air tight seal is created).

In certain embodiments, the systems further comprise the pneumatic component, wherein the pneumatic component is capable of generating the negative pressure. In further embodiments, the pneumatic component is at or near the proximal end of the liquid dispensing component. In further embodiments, the negative pressure generated by the pneumatic component is sufficiently strong to draw the at least one cell in the liquid sample through the detection channel into the dispensing channel. In other embodiments, the dispensing micro-channel has a diameter from about 50 to about 250 micrometers (e.g., 50 . . . 100 . . . 175 . . . 225 . . . or about 250 micrometers). In further embodiments, the detection channel has a diameter from about 1 to about 50 micrometers (e.g., 1 . . . 10 . . . 34 . . . or about 50 micrometers). In additional embodiments, the detection channel is sized such that only a single cell can enter the detection channel at once, and wherein the single cell is selected from the group consisting of: osteocyte, chondrocyte, nerve cell, epithelial cell, muscle cell, secretory cell, adipose cell, red blood cell, white blood cell, platelet, and thrombocyte.

In further embodiments, the systems further comprise the electronic signal detector. In other embodiments, the pneumatic component is at or near the proximal end of the liquid dispensing component. In additional embodiments, the negative pressure generated by the pneumatic component is sufficiently strong to draw the at least one cell in the liquid sample through the detection channel into the dispensing channel.

Provided herein are systems comprising: a) a fluid movement component configured to: i) aspirate a liquid sample from a source container which comprises a plurality of source wells, and ii) dispense the liquid sample into a multi-well testing device which comprises a plurality of open wells, wherein the fluid movement component comprises a plurality of liquid dispensing components each with a proximal end and a distal end, wherein each of the liquid dispensing components comprises; A) a dispensing micro-channel extending between the proximal end and the distal end of the liquid dispensing component, wherein the dispensing micro-channel has an opening in the distal end of the liquid dispensing component that allows liquid to be dispensed, and wherein the dispensing micro-channel is, or is configured to be, operably linked to a pneumatic component such that negative pressure can be generated in the dispensing micro-channel; B) a cell source component, wherein the cell source comprises a cell reservoir or cell-source channel; C) a detection channel extending between the dispensing channel and the cell source component; and D) a cell detection component comprising: i) a first electrode at least partially in the dispensing channel and configured to be electrically linked to an electronic signal detector, and ii) a second electrode at least partially in the detection channel and configured to be electrically linked to the electronic signal detector; wherein the first and second electrodes are arranged such that when a single cell in a liquid sample enters the detection channel and passes between the first and second electrodes, the single cell is detectable by the electronic signal detector due to a change in current or impedance; and b) the electronic signal detector.

In certain embodiments, the negative pressure can be generated in the dispensing micro-channel when the opening is plugged. In further embodiments, the system further comprise a plug pad, wherein the plug pad comprises a plurality of insertion rods, each of which is sized to plug the opening in the distal end of each of the dispensing micro-channels. In additional embodiments, each of the dispensing micro-channels has a diameter from about 50 to about 250 micrometers (e.g., 50 . . . 112 . . . 175 . . . 225 . . . or about 250 micrometers). In further embodiments, each of the detection channels has a diameter from about 1 to about 50 micrometers (e.g., 1 . . . 15 . . . 35 . . . 45 . . . or about 50 micrometers). In additional embodiments, each of the detection channels is sized such that only a single cell can enter the detection channel at once, and wherein the single cell is selected from the group consisting of: osteocyte, chondrocyte, nerve cell, epithelial cell, muscle cell, secretory cell, adipose cell, red blood cell, white blood cell, platelet, and thrombocyte.

In other embodiments, the multi-well testing device comprises at least 75 of the open wells. In other embodiments, the multi-well testing device comprises at least 3000 of the open wells. In further embodiments, the systems further comprise the multi-well testing device. In additional embodiments, the source container comprises at least 75 source wells. In some embodiments, the electronic signal detector comprises a current meter. In further embodiments, when the single cell is detected by the electronic signal detector, cell number data is generated for one particular open well of the plurality of open wells in the multi-well testing device, wherein the cell number data comprises the location of the one particular open well in the multi-well testing device and the number of cells dispensed into the one particular open well. In other embodiments, the systems further comprise a computer storage and processing component operably linked to the electronic signal detector, wherein the computer storage and processing component is configured to receive the cell number data from the electronic signal detector and process the cell number data to generate a database, wherein the database indicates which of the plurality of open wells were filled and the number of cells in each of the plurality of open wells.

In particular embodiments, the plurality of liquid dispensing components comprises at least four liquid dispensing components. In additional embodiments, the systems further comprise a first securing component configured to secure the source container in place at a first location. In other embodiments, the source container comprises at least 96 source wells. In additional embodiments, the source container is configured to hold at least 384 different liquid samples. In certain embodiments, the systems further comprise the source container at a first location. In additional embodiments, the systems further comprise a second securing component configured to secure the multi-well testing device at a second location. In some embodiments, the systems further comprise a robotic arm component comprising a robotic arm and the fluid movement component. In certain embodiments, the systems further comprise a robotic arm component configured to move between the first location and the second location, wherein the robotic arm component comprises a robotic arm and the fluid movement component. In other embodiments, the systems further comprise a hood component, wherein the hood component encloses all the other recited components. In other embodiments, the hood component provides a sealed and humidified environment for the dispensing.

### DESCRIPTION OF THE FIGURES

FIG. 1 shows an exemplary robotic liquid handling system (70) enclosed in a hood.

FIG. 2 shows an exemplary robotic liquid handling system (70) with the hood removed.

FIG. 3 shows a close up view of an exemplary robotic handling system, including: a fluid movement component (10) which contains a plurality of fluidic channels (40); a source container (20) shown with 384 individual sample source compartments and a first securing component (50) for holding the source container (20) in place; and a multi-well testing device (30), which may be WAFERGEN's 5184-nanowell chip, which is secured in place by a second securing component (60).

FIG. 4 shows an exemplary embodiment of a fluidic channel (40) with a non-conductive nozzle (42) positioned to dispense (via tip 43) into an open well (35) with a first electrode (41) positioned partially inside the non-conductive nozzle (42) and electronically connected to sensing electronics (45), and a second electrode (44) partially inside the non-conductive tip downstream (in regard to dispensing) of the first electrode (41), also electrically connected to the sensing electronics.

FIG. 5 shows an exemplary embodiment of a fluidic channel (40) with a non-conductive nozzle (42) positioned to dispense into an open well (35) with a first electrode (41) positioned partially inside the fluidic channel (40) and electronically connected to sensing electronics (45), and a second electrode partially (44) inside the open well (35), also electrically connected to the sensing electronics (45).

FIG. 6 shows an exemplary embodiment of a fluidic channel with a nozzle (42) positioned to dispense into an open well with a pressure sensor (46) partially inside the fluidic channel and electronically connected to sensing electronics (45).

FIG. 7A shows an exemplary liquid dispensing component, which includes dispensing channel 100 (e.g., micro-channel), detection channel 110, and recirculating channel 120.

FIG. 7B shows an exemplary manifold configuration (47), which includes four nozzles (42), each one with one connection (111) for the dispensing channel and two connections (121) for the recirculating channel.

FIG. 8A-C shows an exemplary liquid dispensing component, which includes a dispensing channel 100 (e.g., micro-channel), detection channel 110, cell reservoir 140 (with focusing zone 150), and cell loading opening 130 at the top of the cell reservoir.

FIG. 9A shows an exemplary dis-assembled fluid movement component (190) attached a fluid source component (235), where the fluid movement component (190) is composed of an upstream electrode conduit (200) that is attachable to a non-conductive conduit (210) which in turn is attachable to a downstream electrode conduit (205), which has dispensing tip (230). The upstream electrode conduit (200) is electrically attached to sensing electronics (45) via first connection wire (220). The downstream electrode conduit (205) is electrically attached to sensing electronics (45) via second connection wire (225).

FIG. 9B shows an exemplary assembled fluid movement component (190) attached a fluid source component (235), where the fluid movement component (190) is composed of an upstream electrode conduit (200) that is attached to a non-conductive conduit (210) which in turn is attached to a downstream electrode conduit (205), which has dispensing tip (230). The connection of these three components forms a fluidic path. The upstream electrode conduit (200) is electrically attached to sensing electronics (45) via first connection wire (220). The downstream electrode conduit (205) is electrically attached to sensing electronics (45) via second connection wire (225).

FIG. 9C also shows an exemplary assembled fluid movement component (190) attached a fluid source component (235), where the fluid movement component (190) is composed of an upstream electrode conduit (200) that is attached to a non-conductive conduit (210) which in turn is attached to a downstream electrode conduit (205), which has dispensing tip (230).

FIG. 10 shows an exemplary fluid movement component (190) attached to a fluid source component (235), where the fluid movement component (190) is composed of an upstream electrode component (200) that is attached to a non-conductive component (210), which is inserted below the fluid level of an open well (35), such that the dispensing tip (230) is below the fluid level. The upstream electrode conduit (200) is attached to sensing electronics (45) via first connection wire (220). A second electrode (44) is in the open well (35) at least partially below the fluid level. The second electrode (44) is attached to the sensing electronics (45) via second connection wire (225).

FIG. 11 shows a cross-section of an exemplary non-conductive conduit (210) having a restrictor element (240). The exemplary non-conductive conduit (210) has an inner wall (217) and outer wall (216). The inner wall (217) forms a liquid flow path (218) that leads down to a focusing cone (219) and single-cell channel (221) which together form the restrictor element (240). The restrictor element (240) restricts the flow of liquid such that only a single cell (250) may pass through the single cell channel (221) at once (e.g., and be detected by a reduction in the conductivity of a circuit established by the electrodes).

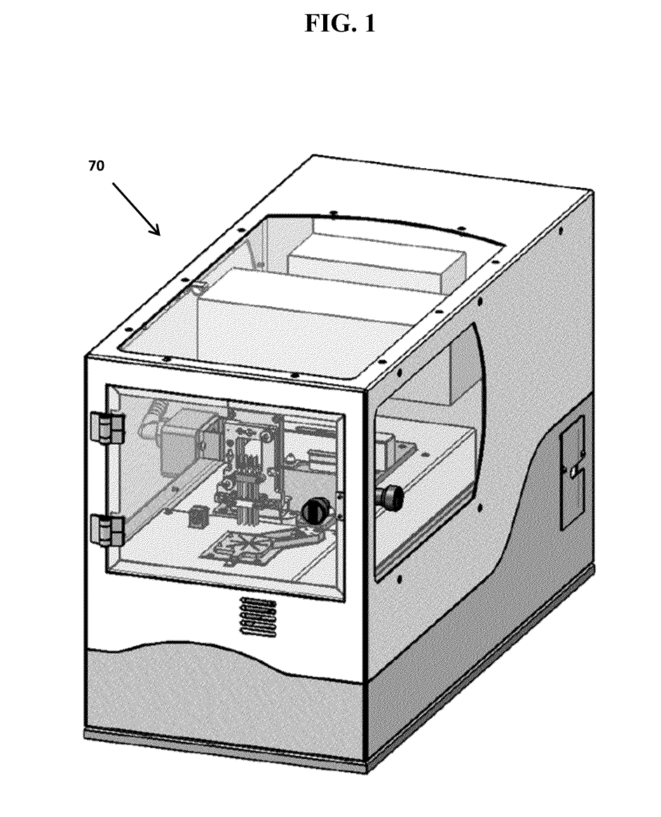

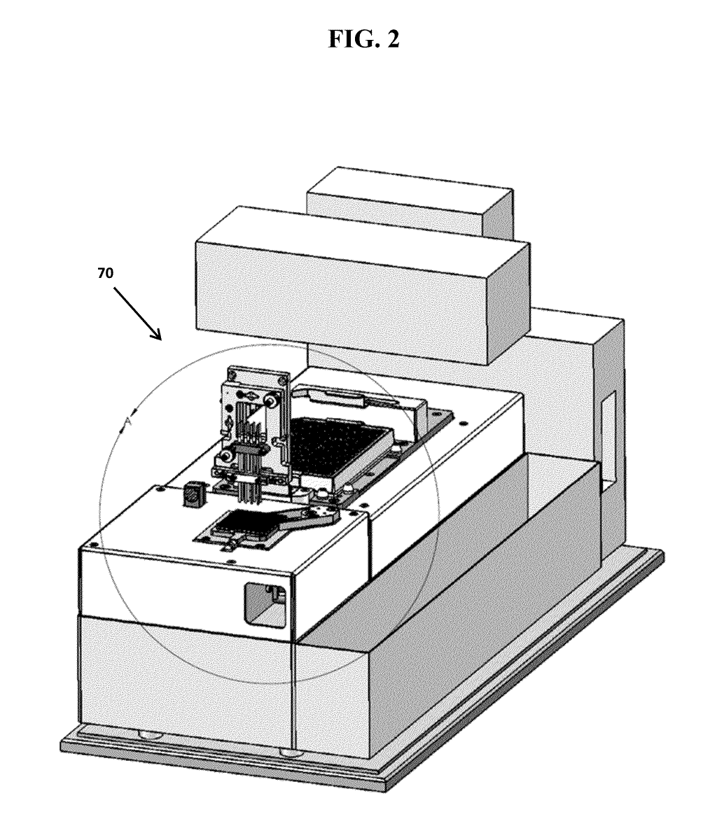

### DETAILED DESCRIPTION

The present invention provides methods, device, assemblies, and systems for counting and dispensing single or multiple cells (e.g., into the open wells of a multi-well testing device). In certain embodiments, the systems comprise: a) a fluid movement component composed of upstream and downstream electrode conduits connected to a non-conductive conduit, and b) an electronic signal detector electrically linked to the upstream and downstream electrode conduits such that, when a fluid is present in the fluid movement component, an electrical circuit is established that is altered when a cell passes through the non-conductive conduit. In other embodiments, the systems comprises a) a fluid movement component composed of an upstream electrode conduit connected to a non-conductive conduit, b) an in-well electrode, and c) an electronic signal detector electrically linked to the upstream electrode conduit and the in-well electrode such that, when: i) a fluid is present in the fluid movement component, ii) the distal end of the non-conductive conduit is in a fluid-contain well, and iii) the in-well electrode is in the fluid-containing well, then an electrical circuit is established that is altered when a cell passes through the non-conductive conduit.

In certain embodiments, the systems employ a plurality of fluidic channels each with a nozzle, where a first electrode is in each fluidic channel and a second electrode is either downstream of the first electrode in the nozzle or is in, or configured to be in, a source well of a source container such that a coulter counter is established allowing the detection and counting of single cells being dispensed or aspirated. In other embodiments, the first and second electrodes are replaced by a pressure sensor. In other embodiments, provided herein are liquid dispensing components with a detection channel between a dispensing micro-channel and a cell re-circulating channel (or cell reservoir), where negative pressure exerted on the dispensing micro-channel causes single cells to traverse the detection channel such that they can be counted and/or sized based on the change in impedance in the detection channel.

A particular exemplary embodiment of the systems of the present invention is as follows. Such system may be composed of array of smart tips/nozzles that move with respect to source and destination well plates. The destination well plate may be a high density micro well array such as the 5184-well SMARTCHIP from WAFERGEN. The tips/nozzles are able to aspirate fluid containing cells in suspension, and the system is able to detect and count the number of aspirated cells. For example, the system may be equipped with a sensing device capable of real-time reporting of cell aspiration or dispensing. Hence, the systems and methods enable the manipulation of single or multiple cells. The smart tips/nozzles can dispense the cell(s) at a destination well(s) or location(s) where the cell(s) can be processed further, for example, for genomic analysis.

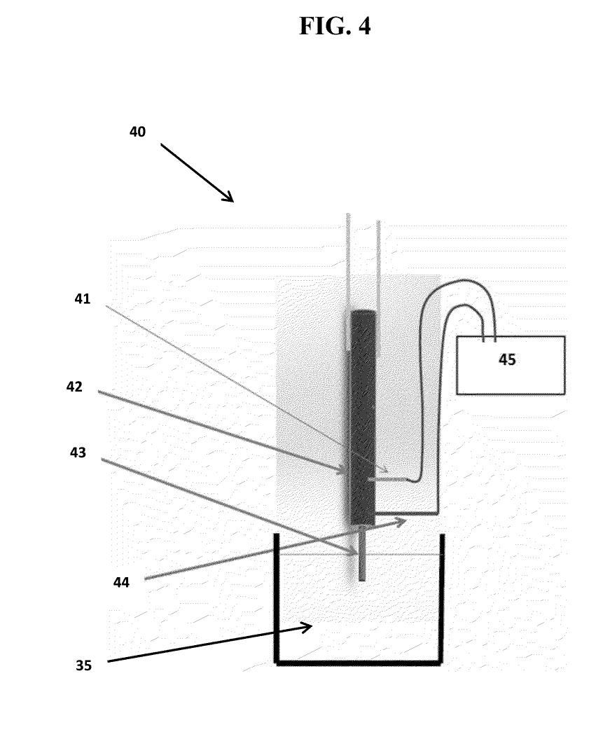

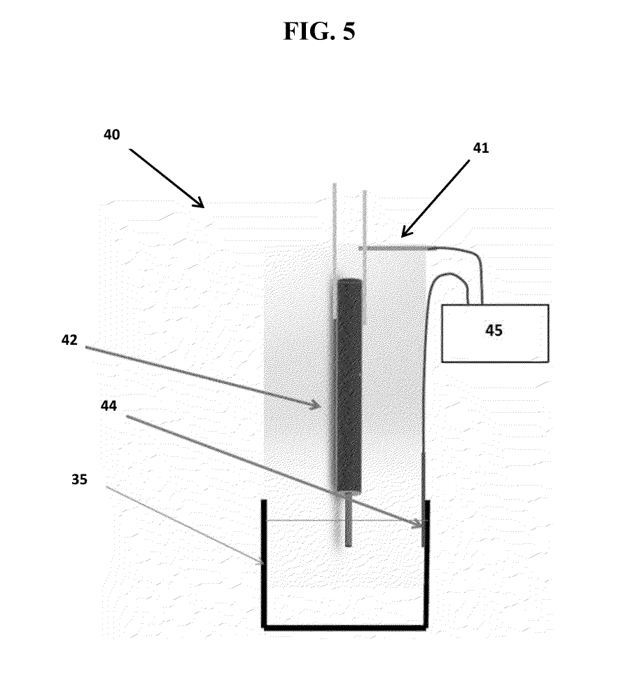

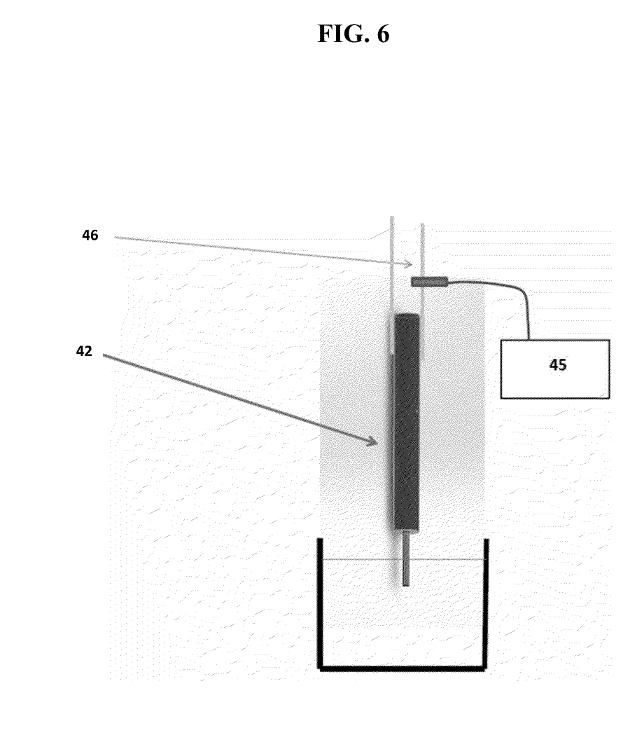

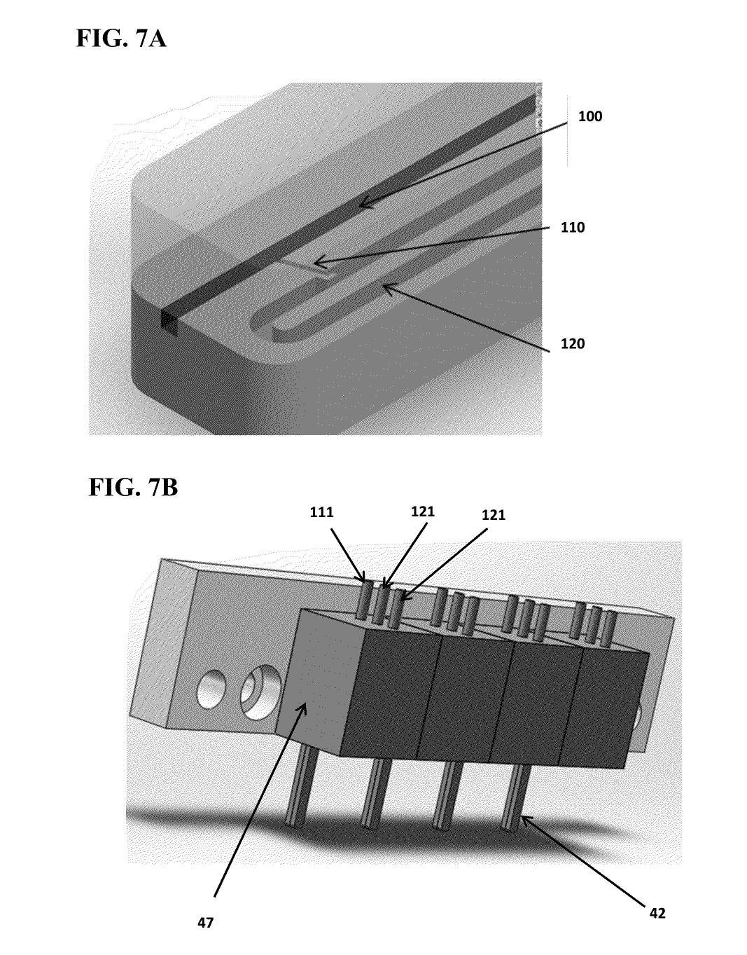

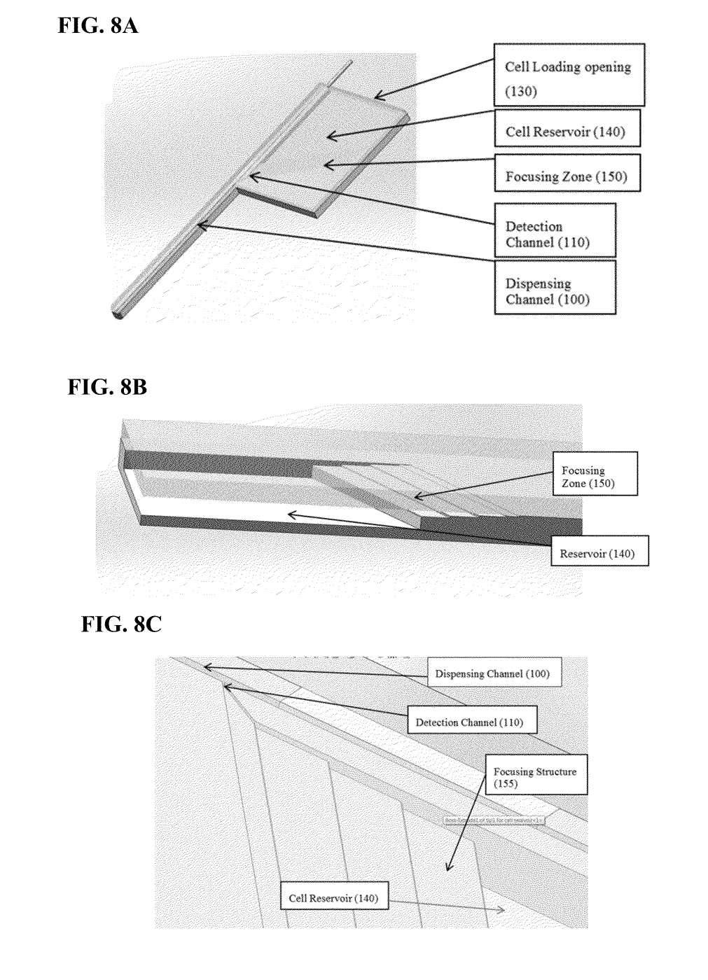

Three exemplary embodiments for cell detection, shown in FIGS. 4-6, are as follows. In a first embodiment, shown in FIG. 4, a cell travelling in the nozzle alters the impedance of a section of the nozzle channel. This variation can be measured using two electrodes located at the nozzle and associated sensing circuitry. The electrodes should be in contact with the fluid/buffer that transports the cells in order to close the electric circuit. As the cells cross the sensing area, they produce impedance changes that allow counting the number of aspirated cells. In another embodiment, shown in FIG. 5, which is also an impedance-based scheme, involves placing one electrode in the buffer well (source) containing the cells, and the second electrode upstream of the nozzle. This would require a source well plate with electrodes. In a third embodiment, shown in FIG. 6, the detection of the cell based on the variations of the fluid pressure field caused by the introduction of cells into the tip, nozzle, or capillary. After aspiration or dispensing using any of these three methods, the cells are dispensed into a micro-well plate (SmartChip) where can be further processed for genetic analysis. In this invention the tips are connected to a high performance robot capable of dispensing fluid into a micro-well plate.

A “filter file” can be generated with information about cells dispensed into the wells of the multi-well testing device. This information can be the number of cells in each well, the morphology, the cell size, or other characteristics derived from the electrical signal obtained by the electrical detector circuitry. The filter file may be used to dispense additional reagents only to the selected wells. These wells are chosen based on some criterion like, viability, morphology, size, etc.

The present invention is not limited by the type of multi-well testing devices (e.g., plates or chips) employed. In general, such devices have a plurality of wells that contain, or are dimensioned to contain, liquid (e.g., liquid that is trapped in the wells such that gravity alone cannot make the liquid flow out of the wells). One exemplary chip is WAFERGEN's 5184-well SMARTCHIP. Other exemplary chips are provided in U.S. Pat. Nos. 8,252,581; 7,833,709; and 7,547,556, all of which are herein incorporated by reference in their entireties including, for example, for the teaching of chips, wells, thermocycling conditions, and associated reagents used therein). Other exemplary chips include the OPENARRAY plates used in the QUANTSTUDIO real-time PCR system (Applied Biosystems). Another exemplary multi-well device is a 96-well or 384-well plate.

The overall size of the multi-well devices may vary and it can range, for example, from a few microns to a few centimeters in thickness, and from a few millimeters to 50 centimeters in width or length. Typically, the size of the entire device ranges from about 10 mm to about 200 mm in width and/or length, and about 1 mm to about 10 mm in thickness. In some embodiments, the chip is about 40 mm in width by 40 mm in length by 3 mm in thickness.

The total number of wells (e.g., nanowells) on the multi-well device may vary depending on the particular application in which the subject chips are to be employed. The density of the wells on the chip surface may vary depending on the particular application. The density of wells, and the size and volume of wells, may vary depending on the desired application and such factors as, for example, the species of the organism for which the methods of this invention are to be employed.

The present invention is not limited by the number of wells in the multi-well device or the number of wells in the multi-well source device. A large number of wells may be incorporated into a device. In various embodiments, the total number of wells on the device is from about 100 to about 200,000, or from about 5000 to about 10,000. In other embodiments the device comprises smaller chips, each of which comprises about 5,000 to about 20,000 wells. For example, a square chip may comprise 125 by 125 nanowells, with a diameter of 0.1 mm.

The wells (e.g., nanowells) in the mulit-well devices may be fabricated in any convenient size, shape or volume. The well may be about 100 μm to about 1 mm in length, about 100 μm to about 1 mm in width, and about 100 μm to about 1 mm in depth. In various embodiments, each nanowell has an aspect ratio (ratio of depth to width) of from about 1 to about 4. In one embodiment, each nanowell has an aspect ratio of about 2. The transverse sectional area may be circular, elliptical, oval, conical, rectangular, triangular, polyhedral, or in any other shape. The transverse area at any given depth of the well may also vary in size and shape.

In certain embodiments, the wells have a volume of from about 0.1 nl to about 1 ul. The nanowell typically has a volume of less than 1 ul, preferably less than 500 nl. The volume may be less than 200 nl, or less than 100 nl. In an embodiment, the volume of the nanowell is about 100 nl. Where desired, the nanowell can be fabricated to increase the surface area to volume ratio, thereby facilitating heat transfer through the unit, which can reduce the ramp time of a thermal cycle. The cavity of each well (e.g., nanowell) may take a variety of configurations. For instance, the cavity within a well may be divided by linear or curved walls to form separate but adjacent compartments, or by circular walls to form inner and outer annular compartments.

A well of high inner surface to volume ratio may be coated with materials to reduce the possibility that the reactants contained therein may interact with the inner surfaces of the well if this is desired. Coating is particularly useful if the reagents are prone to interact or adhere to the inner surfaces undesirably. Depending on the properties of the reactants, hydrophobic or hydrophilic coatings may be selected. A variety of appropriate coating materials are available in the art. Some of the materials may covalently adhere to the surface, others may attach to the surface via non-covalent interactions. Non-limiting examples of coating materials include silanization reagent such as dimethychlorosilane, dimethydichlorosilane, hexamethyldisilazane or trimethylchlorosilane, polymaleimide, and siliconizing reagents such as silicon oxide, AQUASIL, and SURFASIL. Additional suitable coating materials are blocking agents such as amino acids, or polymers including but not limited to polyvinylpyrrolidone, polyadenylic acid and polymaleimide. Certain coating materials can be cross-linked to the surface via heating, radiation, and by chemical reactions. Those skilled in the art will know of other suitable means for coating a nanowell of a multi-well device, or will be able to ascertain such, without undue experimentation.

An exemplary multi-well device (e.g., chip) may have a thickness of about 0.625 mm, with a well have having dimensions of about 0.25 mm (250 um) in length and width. The nanowell depth can be about 0.525 mm (525 um), leaving about 0.1 mm of the chip beneath a given well. A nanowell opening can include any shape, such as round, square, rectangle or any other desired geometric shape. By way of example, a nanowell can include a diameter or width of between about 100 μm and about 1 mm, a pitch or length of between about 150 μm and about 1 mm and a depth of between about 10 μm to about 1 mm. The cavity of each well may take a variety of configurations. For instance, the cavity within a nanowell may be divided by linear or curved walls to form separate but adjacent compartments.

The wells (e.g., nanowells) of the multi-well device may be formed using, for example, commonly known photolithography techniques. The nanowells may be formed using a wet KOH etching technique, an anisotropic dry etching technique, mechanical drilling, injection molding and or thermoforming (e.g., hot embossing).

Reagents contained within the liquid in the multi-well device depend on the reaction that is to be run with the single cell that is deposited into each well. In an embodiment, the wells contain a reagent for conducting the nucleic acid amplification reaction. Reagents can be reagents for immunoassays, nucleic acid detection assays including but not limited to nucleic acid amplification. Reagents can be in a dry state or a liquid state in a unit of the chip. In an embodiment, the wells contain at least one of the following reagents: a probe, a polymerase, and dNTPs. In another embodiment, the wells contain a solution comprising a probe, a primer and a polymerase. In various embodiments, each well comprises (1) a primer for a polynucleotide target within said standard genome, and (2) a probe associated with said primer which emits a concentration dependent signal if the primer binds with said target. In various embodiments, each well comprises a primer for a polynucleotide target within a genome, and a probe associated with the primer which emits a concentration dependent signal if the primer binds with the target. In another embodiment, at least one well of the chip contains a solution that comprises a forward PCR primer, a reverse PCR primer, and at least one FAM labeled MGB quenched PCR probe. In an embodiment, primer pairs are dispensed into a well and then dried, such as by freezing. The user can then selectively dispense, such as nano-dispense, the sample, probe and/or polymerase.

In other embodiments of the invention, the wells may contain any of the above solutions in a dried form. In this embodiment, this dried form may be coated to the wells or be directed to the bottom of the well. The user can add a mixture of water and the captured cells to each of the wells before analysis. In this embodiment, the chip comprising the dried down reaction mixture may be sealed with a liner, stored or shipped to another location.

The multi-well devices, with a single cell in each well, may be used for genotyping, gene expression, or other DNA assays preformed by PCR. Assays performed in the plate are not limited to DNA assays such as TAQMAN, TAQMAN Gold, SYBR gold, and SYBR green but also include other assays such as receptor binding, enzyme, and other high throughput screening assays. In some embodiments, a ROX labeled probe is used as an internal standard.

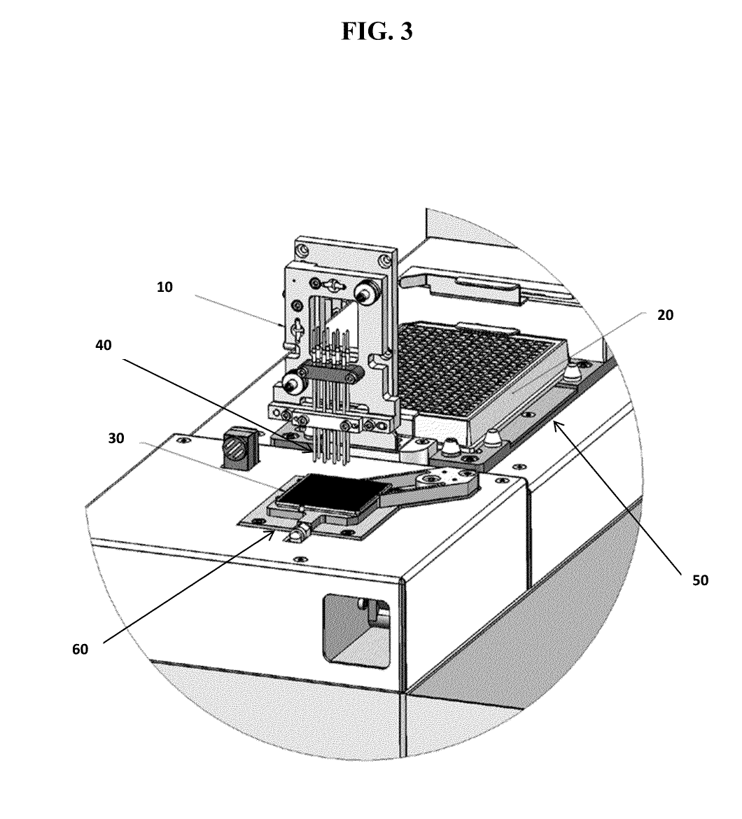

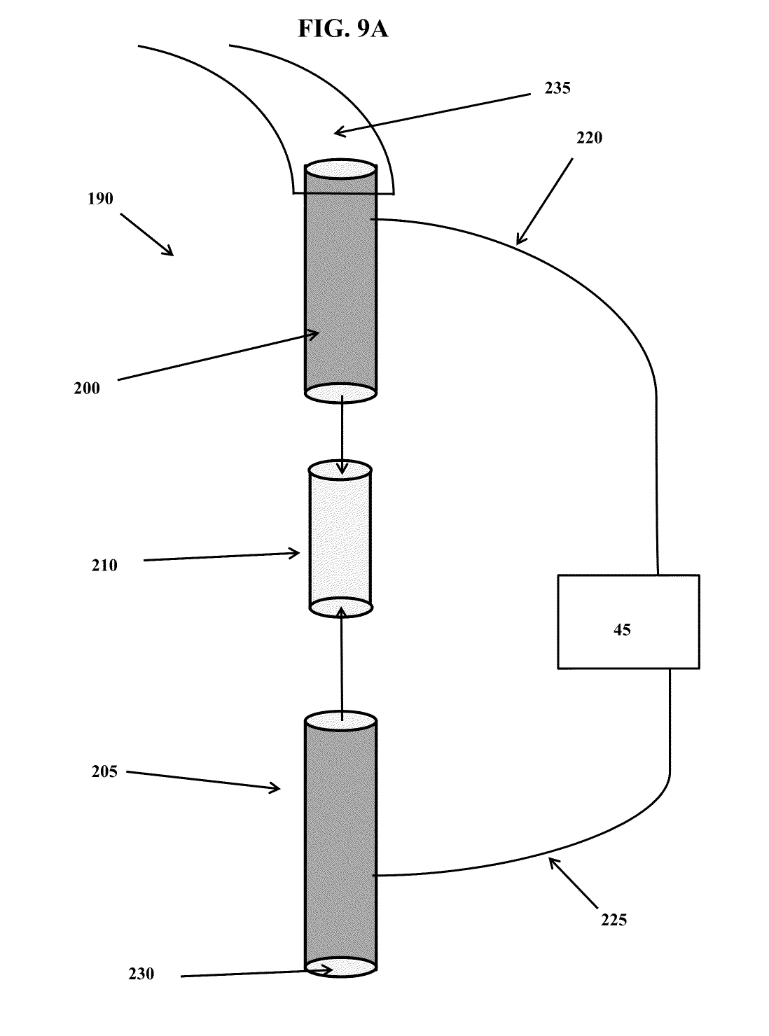

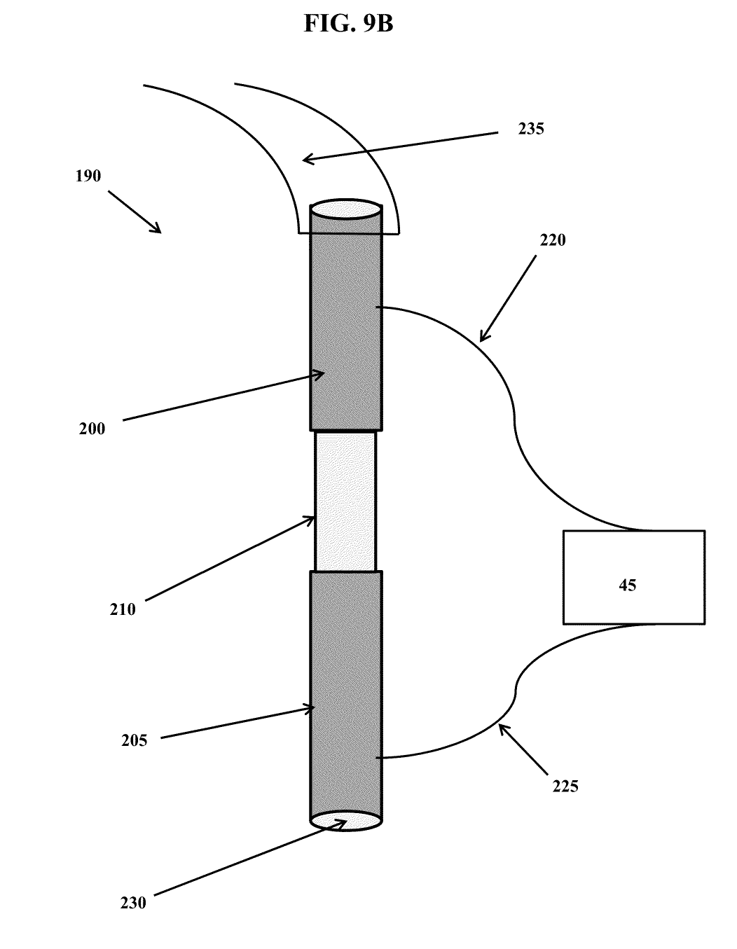

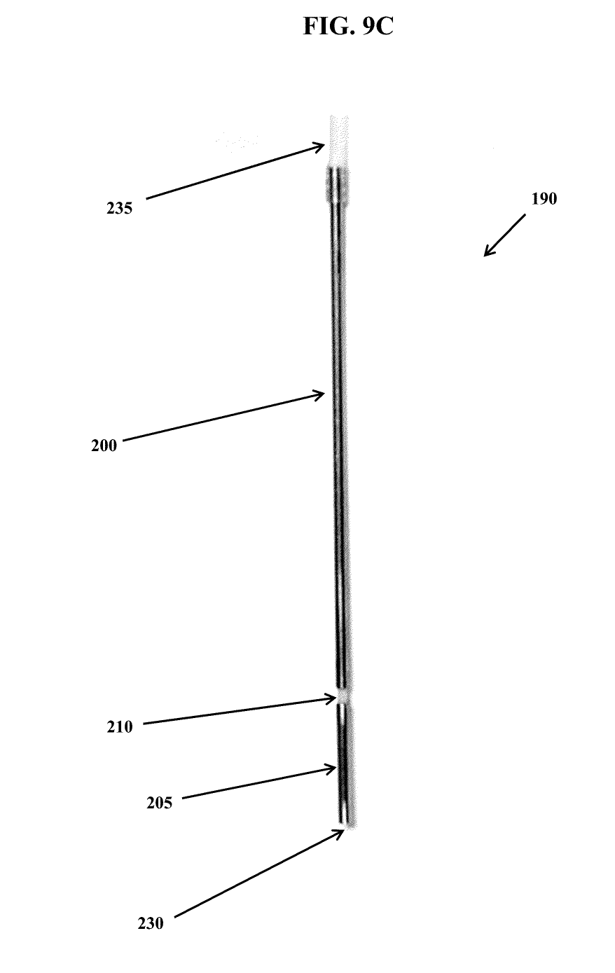

In certain embodiments, the present disclosure provides fluid movement components that allow the movement of liquid and sensing of cells using at least an upstream electrode conduit, a non-conductive conduit, a either a downstream electrode conduit or a second electrode (e.g., in-well electrode) present in a well. Such fluid movement components, when a cell containing liquid is introduced (as an electrolyte), allows a current to be established. Cells entering the fluid movement component, as they pass through the non-conductive component, causes a reduction in conductivity, which can be detected by the sensing components. Exemplary embodiments of such fluid movement components are described below with reference to FIGS. 9-11. Such fluid movement components may serve as the fluidic channels (40) in the automated device shown in FIG. 3 or similar devices.

FIG. 9A shows an exemplary dis-assembled fluid movement component (190) attached a fluid source component (235). The fluid source component (235) may be, for example, a flexible tube or other type of channel, and provide the liquid carrying cells that are delivery to the fluid movement component (190). The fluid movement component (190) is composed of an upstream electrode conduit (200) that is attachable to a non-conductive conduit (210) which in turn is attachable to a downstream electrode conduit (205), which has dispensing tip (230). These three components can be fit together based on size (e.g., push fit) or glued together or manufactured with three zones (e.g., with a 3-D printer). For example, the diameter of the non-conductive component may be slightly smaller or larger than the upstream or downstream components, and be somewhat deformable (e.g., plastic, glass, fused silica, PEEK, etc.), such that all three components can be push-fit together (e.g., with or without epoxy).

The upstream and downstream electrode conduits and configured to move liquid therethrough and simultaneously be electrically conductive. Such electrode conduits may be in the shape of a tube, channel, or other fluid carrying shape, and are composed of electrically material, such as metal (e.g., stainless steel, aluminum, etc.), semiconductors, and some nonmetallic conductors such as graphite and conductive polymer. The length and cross section (e.g., diameter) of the upstream and down stream electrode conduits can be any suitable size. For example, the diameter of these components may be 0.03-0.05 inches (e.g., 0.03 . . . 0.04 . . . 0.042 . . . 0.5 inches), or may be 0.1-2.5 inches (e.g., 0.1 . . . 0.8 . . . 1.5 . . . 1.9 . . . 2.5 inches). In certain embodiments, the length of the upstream and downstream electrode conduits is from 0.3 inches to 15.0 inches (e.g., 0.3 . . . 1.7 . . . 5.4 . . . 10.4 . . . 13.6 . . . 15.0 inches). In certain embodiments, the upstream and downstream electrodes are straight or curved, or some other shape.

In reference to FIGS. 9A and 9B, the upstream electrode conduit (200) is electrically attached to sensing electronics (45) via first connection wire (220). The downstream electrode conduit (205) is electrically attached to sensing electronics (45) via second connection wire (225). Any suitable manner may be used to attach the first and second electrical wires (or other electrical connection component) to the upstream and downstream electrodes. For example, the wires may be attached to the upstream and downstream electrodes (e.g., metal tubes) using epoxy (or other attachment component) or by interference fit. An interference fit is generally achieved by shaping the two mating parts so that one or the other, or both, slightly deviate in size from the nominal dimension such that one part slightly interferes with the space that the other is taking up. For example, one could add a sleeve that is slightly smaller than the outer diameter of the upstream and/or downstream conductive electrodes (e.g., a sleeve over a stainless steel tube), and a wire could be soldered/bonded to the sleeve.

In certain embodiments, the electronic signal detector/sensing electronics (45) is used to establish the circuit and detect the change in conductivity of the circuit when a cell passes through the non-conductive conduit. For example, a Lock-In amplifier (e.g., SR810 and SR830 DSP lock-in amplifier from Stanford Research Systems) may be employed to establish the circuit using an alternating current (A/C), using, for example, a single frequency (e.g., 0.5 kHz-500 kHz). In some embodiments, the signal is 10-20 kHz (e.g., 10.0 . . . 12.0 . . . 14.0 . . . 16.0 . . . 18.0 . . . or 20.0 kHz). The signal of a cell passing through the non-conductive conduit is extracted from this frequency carrier by a signal filter (e.g., analog or digital). In general, among other factors, the noise in such a measurement increases with the bandwidth of the measurement. In certain embodiments, a narrow bandwidth is employed (e.g., a single frequency, such as 15-17 kHz), hence delivering low noise.

FIG. 9B shows an exemplary assembled fluid movement component (190) attached a fluid source component (235), where the fluid movement component (190) is composed of an upstream electrode conduit (200) that is attached to a non-conductive conduit (210) which in turn is attached to a downstream electrode conduit (205), which has dispensing tip (230). FIG. 9B shows the same fluid movement component as FIG. 9A, except with the upstream and downstream electrode conduits attached to the non-conductive conduit. With all of the components attached, and a fluid inside the fluid movement component to serve as an electrolyte, a circuit is established with the first connection wire (220), second wire connection (225) and sensing electronics (45). When a cell in the fluid moves past the non-conductive conduit (210), the conductivity of the circuit is reduced, which can be detected by the sensing electronics (45), thereby allowing a user to control and count the number of cells (or cell) being dispensed (e.g., in a well).

FIG. 9C also shows an exemplary assembled fluid movement component (190) attached a fluid source component (235) which is flexibly plastic tubing, where the fluid movement component (190) is composed of an upstream electrode conduit (200), which is a stainless steel metal tube, that is attached to a non-conductive conduit (210), which is a plastic tube, which in turn is attached to a downstream electrode conduit (205), which is a stainless steel metal tube, which has dispensing tip (230). The upstream and downstream electrode conduits may have a diameter of 0.042 inches, and the diameter of the non-conductive conduit may be 0.032 inches.

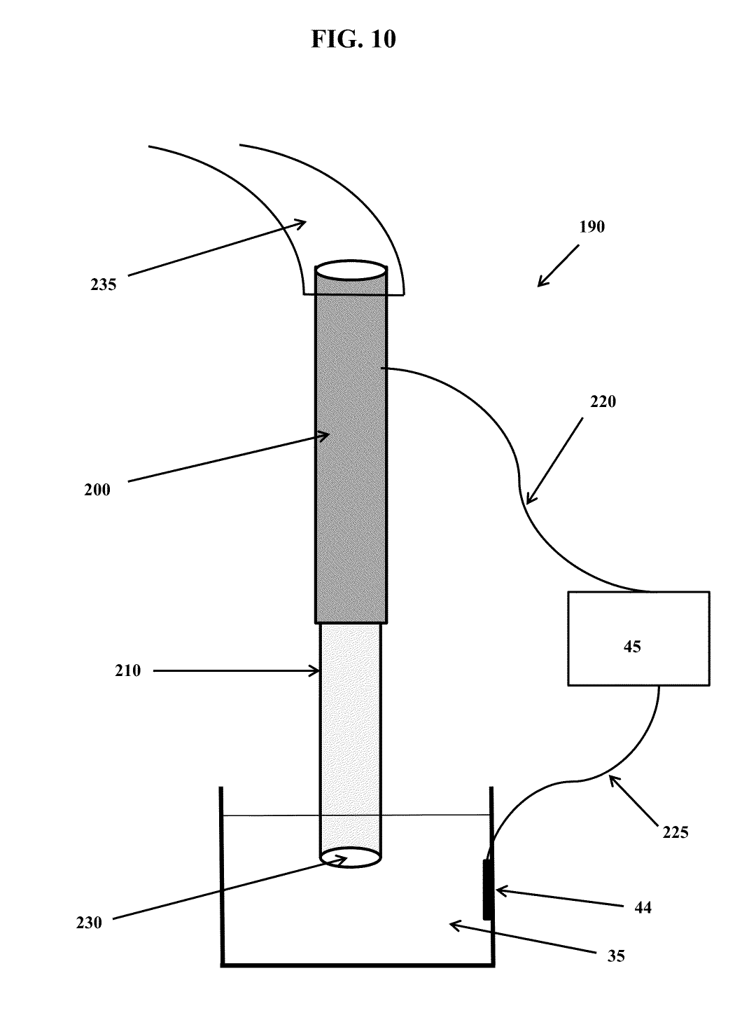

FIG. 10 shows an exemplary fluid movement component (190) attached to a fluid source component (235), where the fluid movement component (190) is composed of an upstream electrode component (200) that is attached to a non-conductive component (210), which is inserted below the fluid level of an open well (35), such that the dispensing tip (230) is below the fluid level. The upstream electrode conduit (200) is attached to sensing electronics (45) via first connection wire (220). A second electrode (44) (e.g., in-well electrode) is in the open well (35) at least partially below the fluid level. The second electrode (44), which is an in-well electrode, is attached to the sensing electronics (45) via second connection wire (225). This arrangement of components allows a circuit to be established when there is fluid in the fluid movement component and in the well. With the established circuit, a cell in the fluid that passes through the non-conductive conduit (e.g., plastic or glass tube) causes the conductivity of the circuit to drop, which can be detected by the sensing electronics (45).

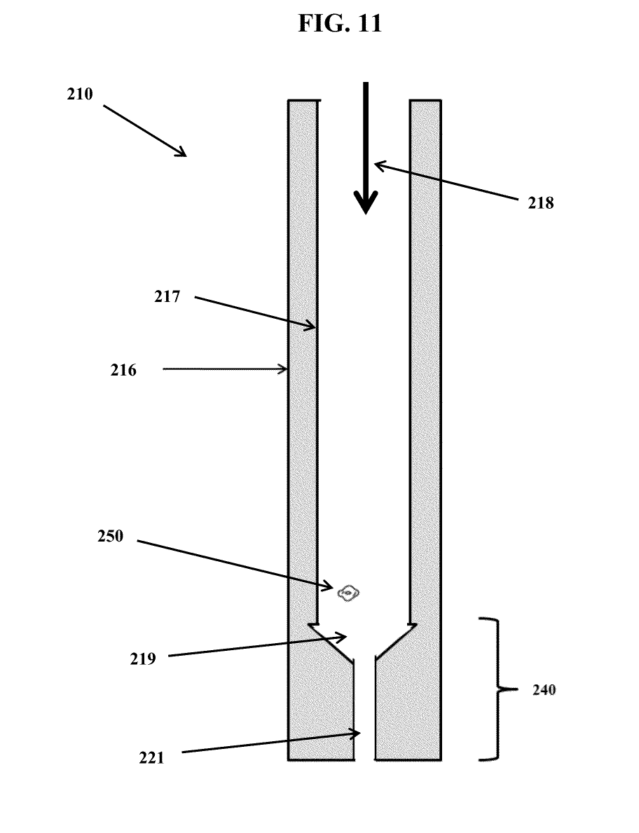

FIG. 11 shows a cross-section of an exemplary non-conductive conduit (210) having a restrictor element (240). The restrictor element is used to allow only one cell to exit the non-conductive element at once (e.g., to aid in dispensing a certain number of cells in a well, such as 1, 2, 3 or more). The exemplary non-conductive conduit (210) has an inner wall (217) and outer wall (216). The inner wall (217) forms a liquid flow path (218) that leads down to a focusing cone (219) and single-cell channel (221) which together form the restrictor element (240). The restrictor element (240) restricts the flow of liquid such that only a single cell (250) may pass through the single cell channel (221) at once (e.g., and be detected by a reduction in the conductivity of a circuit established by the electrodes). The inner diameter of the non-conductive conduit may be, for example, 0.005 to 1.5 inches (e.g., 0.005 . . . 0.15 . . . 0.50 . . . 1.0 . . . 1.5 inches), or larger, or 5 um to 2.0 mm at the narrowest point (e.g., 5 μm . . . 10 um . . . 20 μm . . . 50 μm . . . 100 μm . . . 200 μm . . . 400 μm . . . 600 μm . . . 900 μm . . . 1 mm . . . 1.5 mm . . . or 2.0 mm). The outer diameter of the non-conductive conduit may be, for example, 0.02 to 3.0 inches (e.g., 0.02 . . . 0.032 . . . 0.9 . . . 1.5 . . . 3.0 inches), or larger. The length of the non-conductive conduit (210), and the channel therein, may be about 50 um to about 10 cm, or about 50 um to about 1 cm (e.g., 50 μm . . . 100 μm . . . 700 μm . . . 1 mm . . . 7 mm . . . 9 mm . . . 1 cm). The non-conductive conduit (210) may be composed of any suitable non-conductive material that can also transmit fluid, such as plastic, glass, PEEK, or other materials. In certain embodiments, the non-conductive conduits comprise capillaries (e.g., plastic, glass, fused-silica capillaries) or pulled capillaries (emitters). Examples of such emitters are PICOTIP emitters from New Objective Inc., (Woburn, Mass.), such as SILICATIP, TAPERTIP, GLASSTIP, and QUARTZTIP emitters; see also U.S. Pat. No. 5,788,166, which is herein incorporated by reference in its entirety.

All publications and patents mentioned in the present application are herein incorporated by reference. Various modification and variation of the described methods and compositions of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A system comprising:
a) a fluid movement component configured to dispense at least one cell in a fluid into a container, wherein said fluid movement component comprises:
i) an upstream electrode conduit comprising a proximal end, a distal end, and an upstream fluid-carrying channel, wherein said upstream electrode conduit is electrically conductive and able to transmit said cell in said fluid therethrough;
ii) a downstream electrode conduit comprising a proximal end, a distal end, and a downstream fluid-carrying channel, wherein said downstream electrode conduit is electrically conductive and able to transmit said cell in said fluid therethrough; and
iii) a non-conductive conduit comprising a proximal end, a distal end, and a non-conductive fluid-carrying channel, wherein said non-conductive conduit is non-electrically conductive and able to transmit said cell in said fluid therethrough,
wherein said proximal end of said non-conductive conduit is connected to said distal end of said upstream electrode conduit, and said distal end of said non-conductive conduit is connected to said proximal end of said downstream electrode conduit; and
b) an electronic signal detector that is, or configured to be, electrically linked to both said upstream electrode conduit and said downstream electrode conduit such that:
i) when fluid is present in said fluid movement component an electrical circuit is established, and
ii) when a cell present in said fluid passes through said non-conductive conduit, a change in conductivity, current, or impedance of said electrical circuit is generated that is detectable by said electronic signal detector.

2. The system of claim 1, wherein said electronic signal detector is electrically linked to said upstream electrode conduit via a first connection wire, and said electronic signal detector is electrically linked to said downstream electrode conduit via a second connection wire.

3. The system of claim 1, wherein said non-conductive fluid-carrying channel is between about 50 μm and 1 cm long.

4. The system of claim 1, further comprising a fluid source component attached to proximal end of said upstream electrode conduit.

5. The system of claim 1, wherein said non-conductive fluid-carrying channel has a diameter, at its narrowest point, of between 3 μm and 1.0 mm.

6. The system of claim 1, wherein said at least one cell is selected from the group consisting of: a platelet with a diameter of about 2 μm, a red blood cell with a diameter of about 3 to 8 μm, a neutrophil with a diameter of about 8-10 μm, a lymphocyte with a diameter of about 6-12 μm, an exocrine cell with a diameter of about 10 μm, a fibroblast with a diameter of about 10-15 μm, an osteocyte with a diameter of about 10-20 μm, a chondrocyte or a liver cell with a diameter of about 20 μm, a goblet or ciliated cell with a size of about 50 μm long and 5-10 μm wide, a macrophage with a diameter of about 20-80 μm, a hematopoietic stem cell with a diameter of about 30-40 μm, an adipocyte filled with stored lipid with a diameter of about 70-120 μm, and a neuron with a diameter of about 4-120 μm.

7. The system of claim 1, wherein said non-conductive conduit further comprises a restrictor element, wherein said restrictor element comprises a single cell channel sized to allow only a single cell to pass out of said distal end of said non-conductive component at once.

8. A method of detecting a cell passing through a fluid movement component comprising:
a) providing:
i) system of claim 1, wherein said electronic signal detector is electrically linked to both said upstream electrode conduit and said downstream electrode conduit, and
ii) at least one cell in a fluid;
b) passing said fluid through said fluid movement component such that said electrical circuit is established; and
c) detecting a change in conductivity, current, or impedance of said electrical circuit with said electronic signal detector when said at least one cell in said fluid passes through said non-conductive conduit, thereby detecting said at least one cell moving through said fluid movement component.

9. The method of claim 8, further comprising d) dispensing said at least one cell into a well based on detecting said at least one cell moving through said fluid movement component.

10. An article of manufacture comprising a fluid movement component configured to dispense at least one cell in a fluid into a container, wherein said fluid movement component comprises:
a) an upstream electrode conduit comprising a proximal end, a distal end, and an upstream fluid-carrying channel, wherein said upstream electrode conduit is electrically conductive and able to transmit said cell in said fluid t herethrough;
b) a downstream electrode conduit comprising a proximal end, a distal end, and a downstream fluid-carrying channel, wherein said downstream electrode conduit is electrically conductive and able to transmit said cell in said fluid therethrough; and
c) a non-conductive conduit comprising a proximal end, a distal end,
and a non-conductive fluid-carrying channel, wherein said non-conductive conduit is non-electrically conductive and able to transmit said cell in said fluid therethrough,
wherein said proximal end of said non-conductive conduit is connected to said distal end of said upstream electrode conduit, and said distal end of said non-conductive conduit is connected to said proximal end of said downstream electrode conduit, and
wherein said upstream and downstream electrode conduits are configured to be electrically linked to an electronic signal detector such that:
i) when fluid is present in said fluid movement component an electrical circuit is established, and
ii) when a cell present in said fluid passes through said non-conductive conduit, a change in conductivity, current, or impedance of said electrical circuit is generated that is detectable by said electronic signal detector.

11. The article of manufacture of claim 10, wherein said non-conductive fluid-carrying channel has a diameter at its narrowest point between about 2 μm and 1.0 mm, and a length between about 50 μm and 1 cm.

12. The article of manufacture of claim 10, wherein said non-conductive conduit further comprises a restrictor element, wherein said restrictor element comprises a single cell channel sized to allow only a single cell to pass out of said distal end of said non-conductive component at once.

13. A system comprising:
a) a fluid movement component configured to dispense at least one cell in a fluid, wherein said fluid movement component comprises:
i) an upstream electrode conduit comprising a proximal end, a distal end, and an upstream fluid-carrying channel, wherein said upstream electrode conduit is electrically conductive and able to transmit said cell in said fluid therethrough; and
ii) a non-conductive conduit comprising a proximal end, a distal end, and a non-conductive fluid-carrying channel, wherein said non-conductive conduit is non-electrically conductive and able to transmit said cell in said fluid therethrough,
wherein said proximal end of said non-conductive conduit is connected to said distal end of said upstream electrode conduit;
b) an in-well electrode; and
c) an electronic signal detector that is, or is configured to be, electrically linked to both said upstream electrode conduit and said in-well electrode such that:
i) when: A) fluid is present in said fluid movement component, B) said distal end of said non-conductive conduit is in a fluid-containing well, and C) said in-well electrode is at least partially in said fluid-containing well, then an electrical circuit is established, and
ii) when said cell in said fluid passes through said non-conductive conduit, a change in conductivity, current, or impedance of said electrical circuit is generated that is detectable by said electronic signal detector.

14. The system of claim 13, further comprising said fluid-containing well, wherein at least part of said in-well electrode, and said distal end of said non-conductive conduit, are in said fluid-containing well.

15. The system of claim 13, wherein said non-conductive conduit further comprises a restrictor element, wherein said restrictor element comprises a single cell channel sized to allow only a single cell to pass out of said distal end of said non-conductive component at once.

16. The system of claim 13, wherein said non-conductive fluid-carrying channel has a diameter between 3 μm and 1.0 mm, and a length at its narrowest point between about 50 μm and 1 cm.

17. A method of detecting a cell passing through a fluid movement component comprising:
a) providing:
i) at least one cell in a fluid,
ii) a fluid-containing well, and
iii) said system of claim 13, wherein said electronic signal detector is electrically linked to both said upstream electrode conduit and said in-well electrode, and wherein at least part of said in-well electrode and said distal end of said non-conductive conduit are in said fluid-containing well;
b) passing said fluid through said fluid movement component such that said electrical circuit is established; and
c) detecting a change in conductivity, current, or impedance of said electrical circuit with said electronic signal detector when said at least one cell in said fluid passes through said non-conductive conduit, thereby detecting said at least one cell moving through said fluid movement component.

18. An article of manufacture comprising a fluid movement component configured to dispense at least one cell in a fluid into a container, wherein said fluid movement component comprises:
a) an upstream electrode conduit comprising a proximal end, a distal end, and an upstream fluid-carrying channel, wherein said upstream electrode conduit is electrically conductive and able to transmit said cell in said fluid therethrough; and
b) a non-conductive conduit comprising a proximal end, a distal end,
and a non-conductive fluid-carrying channel, wherein said non-conductive conduit is non-electrically conductive and able to transmit said cell in said fluid therethrough,
wherein said proximal end of said non-conductive conduit is connected to said distal end of said upstream electrode conduit, and
wherein said upstream electrode conduit is configured to be electrically linked to an in-well electrode and an electronic signal detector such that:
i) when: A) fluid is present in said fluid movement component, B) said distal end of said non-conductive conduit is in a fluid-containing well, and C) at least part of said in-well electrode is in said fluid-containing well, then an electrical circuit is established, and
ii) when said cell in said fluid passes through said non-conductive conduit, a change in conductivity, current, or impedance of said electrical circuit is generated that is detectable by said electronic signal detector.

19. The article of manufacture of claim 18, wherein said non-conductive fluid-carrying channel has a diameter at its narrowest point of between 3 μm and 1.0 mm, and a length between 50 μm and 1 cm.

20. The article of manufacture of claim 18, wherein said non-conductive conduit further comprises a restrictor element, wherein said restrictor element comprises a single cell channel sized to allow only a single cell to pass out of said distal end of said non-conductive component at once.
